(19) United States
(12) Patent Application Publication
(10) Pub. No.: US 2003/0016231 A1
(43) Pub. Date: Jan. 23, 2003

(54) Dithering method and dithering device

(76) Inventor: Gerard David Hei La, Eindhoven (NL)

Correspondence Address: U.S. Philips Corporation, 580 White Plains Road, Tarrytown, NY, 10591, US

(21) Appl. No.: 10/153,259

(22) Filed: May 22, 2002

(30) Foreign Application Priority Data
May 23, 2001 (EP) 01201976.6

(51) Int. Cl. G09G 5/02

(52) U.S. Cl. 345/596

(57) ABSTRACT

The present invention provides a dithering method for assigning a digital value of N bits to a pixel, wherein the image signal comprises a pixel value of M bits, wherein M is greater than N (M>N), wherein a (pseudo-)random number (M−N) of bits is added to an original pixel value of M bits, the result of the addition is then truncated at N bits and wherein the random values which are added to two or more adjacent pixels values are mutually correlated.

The present invention relates to a dithering method and a dithering device. Particularly in the case of Plasma Display Panels (PDPs), but also in the case of other devices such as Plasma Addressed Liquid Crystals (PALCs), one of the problems which occurs is that because of physical limitations the number of bits available for a pixel value of a particular color cannot be displayed in sufficient depth. Owing to lack of time six to eight bits per image cycle are for instance possible in the case of PDPs, while the (color) information is available in for instance ten to twelve bits.

Dithering algorithms are known, such as that of Floyd-Steinberg, error diffusion etc., for compensating truncation errors.

It is known, for instance from the U.S. Pat. No. 5,404,176 to add a bit value of a color component (R, G, B) and a random number and thus compensate for a truncation error.

It is an object of the present invention to provide a good dithering method and dithering device, wherein the calculations are not very complex and the required hardware and/or software can remain limited.

The present invention provides a dithering method for assigning a digital value of N bits to a color component of a pixel, wherein the image signal comprises a pixel value of M bits, wherein M is greater than N (M>N), wherein a (pseudo-)random number (M−N) of bits is added to an original pixel value of M bits, the result of the addition is then truncated at N bits and wherein the two or more random values which are added to two or more adjacent (color) pixel values are mutually correlated.

According to the present invention the (software) computation for dithering noise can be combined with the gamma correction which is especially important for PDPs. If combined with gamma correction the algorithm according to the present invention adds 27 MHz instead of 119 MHz for the Floyd-Steinberg algorithm of computing capacity for a processor of 1000 MHz, e.g. a load of less than 3% instead of about 12% relative to the capacity of the processor.

Two of the random numbers are preferably each other's inverse and more preferably four random numbers originate from a common random generator wherein pairs of the numbers are each other's inverse. So-called ‘blue noise’ is hereby obtained in a higher frequency range than if the values were uncorrelated, which is advantageous for the Human Visual System (HVS).

In order to keep the total luminance value of successive pixels as constant as possible, the respective different mutually correlated random numbers are added as far as possible to the respective pixel values for red (R), green (G) and blue (B) of successive pixels.

The present invention further provides a dithering device which particularly makes use of a plasma display panel.

Further advantages, features and details of the present invention will be elucidated on the basis of the following description of a preferred embodiment thereof with reference to the annexed drawings, in which:

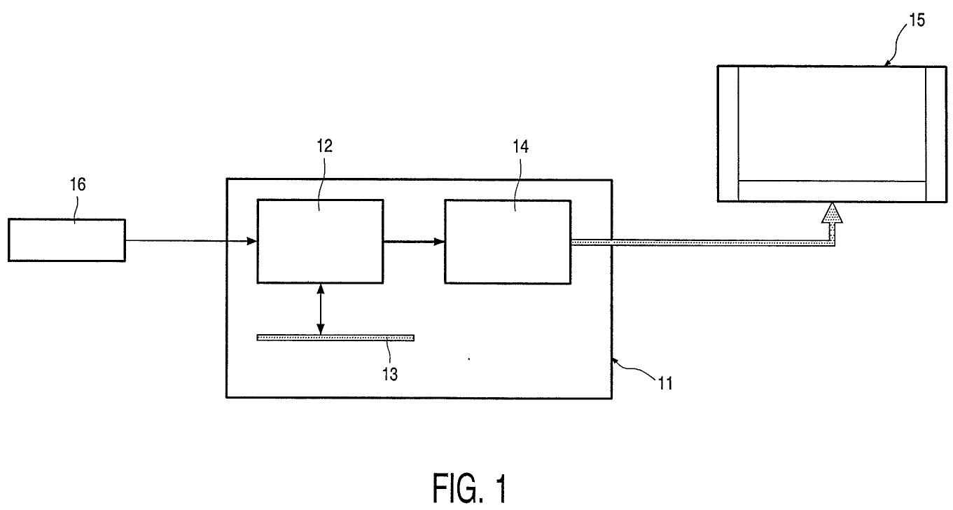

FIG. 1 shows a block diagram of a preferred embodiment of a hardware configuration wherein a method and device according to the present invention are applied;

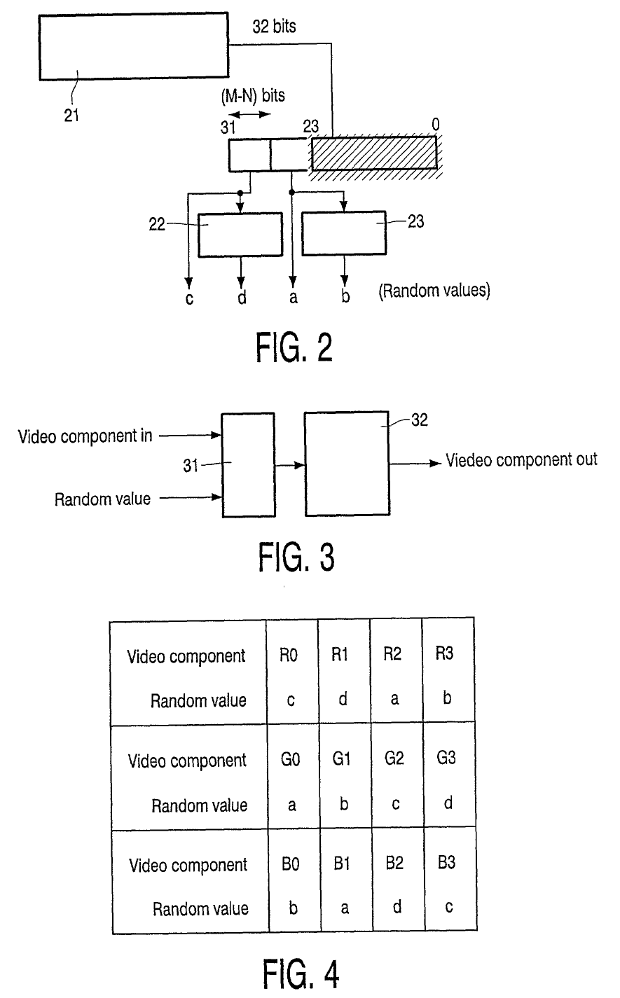

FIG. 2 shows a block diagram of a preferred embodiment of the applied method;

FIG. 3 shows a block diagram of a preferred embodiment of the applied device;

FIG. 4 shows a table of the addition of the different values of color components of successive pixels in a video image obtained from the block diagram of FIG. 2; and

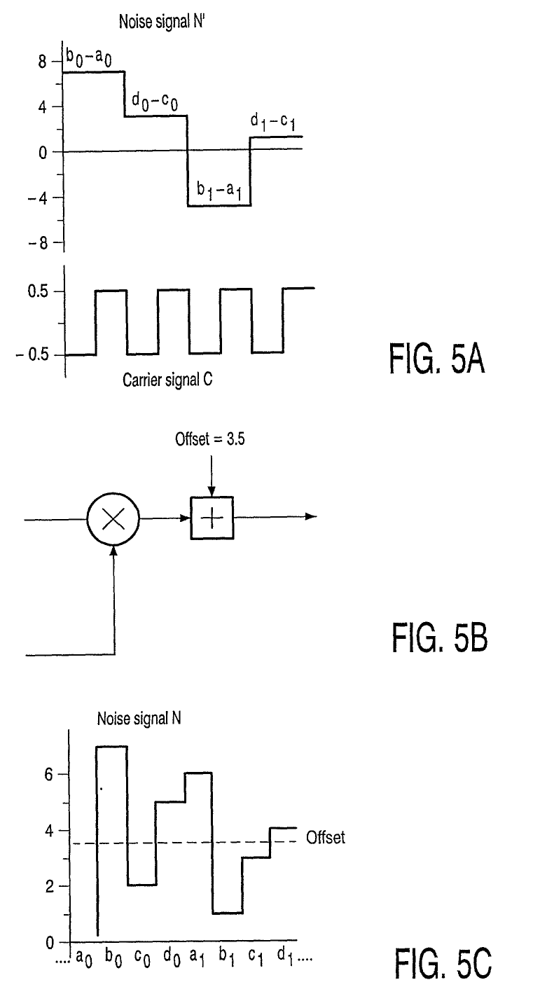

FIGS. 5A, 5B and 5C are graphs of an example of high frequency blue noise included in the embodiment of FIGS. 1-3.

A host personal computer (PC) 11 is provided with a so called TriMedia TM 1100 development board 12 which is connected to an internal bus 13 of the host PC and a custom PDP interface 14 for connecting to a schematically designated Plasma Display 15, and is connected to a video source 16 which generates an analog signal (for instance CVBS- or YC format signals) which is converted in the TriMedia board to a digital signal, for instance in a YUV 4:2:2 interlaced video stream. The TriMedia processor converts this image into progressive RGB data (of 8 bits per color i.e. a 24 bit RGB signal).

In the preferred embodiment a linear congruential generator 21 (FIG. 2) supplies a pseudo-random number of 32 bits, for instance according to the formula:

Xₙ₊₁=(A·Xₙ+C) (modulo 2³²)

The longest possible period of the generator is obtained for A=1, 5, 9, 13 . . . (1(mod4)) and C is odd. From the more significant part of the pseudo-random generator two pseudo-random numbers of (M−N) bits are obtained, c respectively a, while inverted values d respectively b are also obtained therefrom by means of inverter 22, 23 respectively.

The more significant bits of the output of the generator 21 are even less correlated than the more significant bits thereof.

In the present embodiment the number M is for instance 12 and the number N for instance 7, so that two numbers of 5 bits are added as noise in an adder 31 (FIG. 3), whereafter the sum is truncated in truncating member 5 32 a ‘video component out’ (R, G or B) of 7 bits which are supplied as video component to the PDP display 15.

By likewise applying the inverted values b and d the noise is formed to a higher frequency range, which is less disturbing to the Human Visual System.

The mutually correlated values a-d are obtained after a single iteration to the noise generator 21, whereby so-called ‘blue noise’ is obtained (FIGS. 5A, 5B and 5C). An example of a noise signal N (FIG. 5C) is for instance added to a G (or R or B) ‘video component in’. This signal N can be decomposed into a noise signal N′ and modulating carrier wave C.

As shown in FIG. 4, the values a,b,c and d are added to the color signals R0-R4, G0-G4 and B0-B4 to four successive horizontal pixels such that two of these adjacent color values at a time are mutually correlated, which has the above stated advantageous effect on the Human Visual System.

In accordance with this diagram the luminance Y(=0.3R+0.59G+0.11B) is moreover maintained for adjacent pixels (FIGS. 5A, 5B and 5C).

The present invention is not limited to the above described preferred embodiment; the rights sought are however defined by the following claims, within the scope of which many modifications can be envisaged, especially with respect to the possible exchange of hardware and software for certain parts of the device (and method)

1. A dithering method for assigning a digital value of N bits to a pixel, wherein the image signal comprises a pixel value of M bits, wherein M is greater than N (M>N), wherein a (pseudo-)random number of (M−N) bits is added to an original pixel value of M bits, the result of the addition is then truncated at N bits and wherein the random values which are added to two or more adjacent (color) pixel values are mutually correlated.

2. Method as claimed in claim 1, wherein two of the random numbers are each other's inverse.

3. Method as claimed in claim 1, wherein four random numbers originate from a common random generator and wherein pairs of the numbers are each other's inverse.

4. Method as claimed in claim 1, wherein different mutually correlated random numbers are added to the pixel value for red, green and blue of the same pixel.

5. Method as claimed in claim 1, wherein the random values are mutually correlated in accordance with the table of FIG. 4.

6. Method as claimed in claim 1, wherein the noise is formed in a relatively high frequency range.

7. Device for performing the method of any of the foregoing claims, wherein the device comprises:
a display member; and
electronics connected to a display member, wherein the electronics comprise a noise generator for supplying a pseudo-random number of a predetermined number of bits in addition to adding and truncation means for adding and truncating the addition of the random values to an input video component.

8. Device as claimed in claim 7, wherein the noise generator supplies three or four pseudo-random values and the adding and truncation means add three or more random values to the R, G and B color signals of an input video signal.

9. Device as claimed in claim 7, wherein the display is a plasma display panel.

10. Device as claimed in claim 7, wherein a method according to claim 1 is used.
